(19) United States
(12) Patent Application Publication
(10) Pub. No.: US 2008/0265740 A1
(43) Pub. Date: Oct. 30, 2008

(54) PLASMA DISPLAY PANEL AND METHOD FOR FABRICATING THE SAME

(76) Inventors: Young Han Lee, Suwon-si (KR); Ho Seong Choi, Paju-si (KR); Sung Chun Choi, Anyang-si (KR)

Correspondence Address: KED & ASSOCIATES, LLP, P.O. Box 221200, Chantilly, VA, 20153-1200, US

(21) Appl. No.: 12/061,226

(22) Filed: Apr. 2, 2008

(30) Foreign Application Priority Data
Apr. 25, 2007 (KR) 10-2007-0040245

(51) Int. Cl. H01J 1/62; H01J 9/38

(52) U.S. Cl. 313/489; 445/11

(57) ABSTRACT

A plasma display panel is disclosed, which includes a first panel provided with an address electrode, a first dielectric, and a phosphor on a first substrate, and a second panel bonded to the first panel by interposing a barrier therebetween, including a transparent electrode, a bus electrode, a second dielectric provided with high dielectric particles, and a protective layer on a second substrate.

This application claims the benefit of the Korean Patent Application No. 10-2007-0040245, filed on Apr. 25, 2007, which is hereby incorporated by reference as if fully set forth herein.

### BACKGROUND OF THE INVENTION

1. Field of the Invention

The present invention relates to a plasma display panel, and more particularly, to an upper dielectric layer of a plasma display panel and a method for fabricating the same.

2. Discussion of the Related Art

With the advent of the multimedia age, a display device, which is finer and larger and can display a more natural color, is being required. However, a current cathode ray tube (CRT) has a limitation in configuring a large screen of 40 inch or greater. In this respect, display devices such as a liquid crystal display, a plasma display panel, and a projection television (TV) have been rapidly developed for enlargement to the video field of high picture quality in their use.

The display devices such as the aforementioned PDP are characterized in that they can be fabricated at a thin thickness and facilitates fabrication of a flat large screen of 60 inch to 80 inch unlike the CRT which has self-luminance. Also, the display devices such as the aforementioned PDP are definitely different from the conventional CRT in view of its style and design.

The plasma display panel includes a rear panel provided with an address electrode, a front panel provided with sustain electrode pairs, and discharge cells defined by a barrier, wherein each discharge cell is coated with a phosphor. In this case, an inert gas is filled within each discharge cell, wherein the inert gas contains a main discharge gas such as neon, helium, and a mixture gas of neon and helium and xenon of a small content. If discharge occurs within a discharge area between the front panel and the rear panel, vacuum ultraviolet rays are generated. The generated vacuum ultraviolet rays enter the phosphor to generate visible rays, whereby a screen is displayed by the visible rays.

A dielectric layer is formed in the front panel of the plasma display panel to protect the sustain electrode pairs. The dielectric layer includes a low melting point glass formed in the front panel. Conventionally, a dielectric ratio or thickness of the dielectric layer is varied to control wall charges accumulated on a surface of the dielectric layer.

However, if the dielectric ratio of the dielectric layer increases or the thickness of the dielectric layer decreases to accumulate more wall charges on the surface of the dielectric layer, the charges accumulated in the sustain electrode pairs increase. For this reason, since sustain current and luminance increase, there is limitation in increasing the dielectric ratio of the dielectric layer or varying the thickness of the dielectric layer.

### SUMMARY OF THE INVENTION

Accordingly, the present invention is directed to a plasma display panel and a method for fabricating the same, which substantially obviate one or more problems due to limitations and disadvantages of the related art.

An object of the present invention is to provide a plasma display panel and a method for fabricating the same, in which the amount of wall charges accumulated on a surface of a dielectric layer is controlled without change of a dielectric ratio of the dielectric layer provided in an upper panel of the plasma display panel.

Another object of the present invention is to provide a plasma display panel and a method for fabricating the same, in which the amount of wall charges accumulated on a surface of a dielectric layer is controlled without change of a thickness of the dielectric layer provided in an upper panel of the plasma display panel.

Other object of the present invention is to provide a plasma display panel and a method for fabricating the same, in which more wall charges are locally accumulated on a surface of a dielectric layer of the plasma display panel.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a plasma display panel includes a first panel provided with an address electrode, a first dielectric layer, and a phosphor on a first substrate, and a second panel bonded to the first panel by interposing a barrier therebetween, including a transparent electrode, a bus electrode, a second dielectric layer provided with high dielectric particles, and a protective layer on a second substrate.

In another aspect of the present invention, a plasma display panel includes a first panel provided with an address electrode, a first dielectric layer, and a phosphor on a first substrate, and a second panel bonded to the first panel by interposing a barrier therebetween, including a transparent electrode, a bus electrode, a second dielectric layer, a third dielectric layer provided with high dielectric particles, and a protective layer.

In other aspect of the present invention, a method for fabricating a plasma display panel includes forming an address electrode, a first dielectric layer, and a barrier on a first substrate, coating a phosphor within a cell divided by the barrier, forming a transparent electrode and a bus electrode on a second substrate, coating, drying and firing a second dielectric layer material including high dielectric particles on the second substrate, forming a protective layer on the second dielectric layer, and bonding the first substrate and the second substrate to each other.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view illustrating a front panel of a plasma display panel according to the first embodiment of the present invention;

FIG. 2 is a sectional view illustrating a front panel of a plasma display panel according to the second embodiment of the present invention;

FIG. 3 is a sectional view illustrating a front panel of a plasma display panel according to the third embodiment of the present invention;

FIG. 4 is a sectional view illustrating a plasma display panel according to one embodiment of the present invention;

FIG. 5 illustrates a driving gear and a connecting part of a plasma display panel according to the present invention;

FIG. 6 illustrates a substrate line structure of a general tape carrier package;

FIG. 7 illustrates a plasma display panel according to another embodiment of the present invention;

FIG. 8A to FIG. 8J illustrate a method for fabricating a plasma display panel according to the embodiment of the present invention; and

FIG. 9A and FIG. 9B illustrate a bonding process of a front substrate and a rear substrate of a plasma display panel.

### DETAILED DESCRIPTION OF THE INVENTION

Reference will now be made in detail to the preferred embodiments of the present invention, examples of which are illustrated in the accompanying drawings.

In the accompanying drawings, thickness has been enlarged to definitely express several layers and areas, and it is to be understood that a thickness ratio between respective layers shown in the drawings does not illustrate an actual thickness ratio.

A plasma display panel according to the present invention includes a front panel, a rear panel, and a barrier, wherein the front panel and the rear panel are bonded to each other by interposing the barrier therebetween.

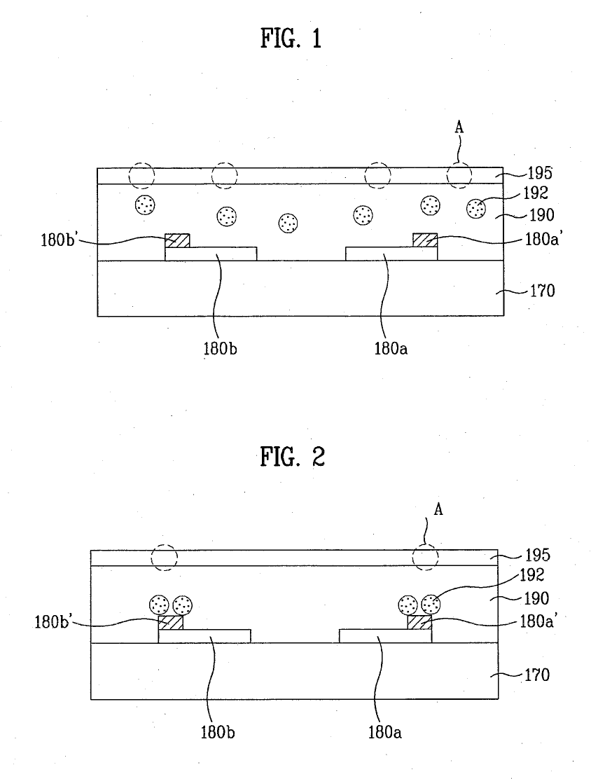

FIG. 1 is a sectional view illustrating a front panel of a plasma display panel according to the first embodiment of the present invention.

As shown in FIG. 1, a front panel of the plasma display panel according to the present invention includes sustain electrode pairs consisting of a pair of transparent electrodes 180a and 180b of indium tin oxide (ITO) formed on a front substrate 170 in one direction, and a pair of bus electrodes 180a′ and 180b′ of a metal material. The front panel of the plasma display panel according to the present invention further includes a dielectric layer 190 and a protective layer 195, which are sequentially formed on the entire surface of the front substrate 170 while covering the sustain electrode pairs.

The front substrate 170 is formed by a process such as milling and cleaning of glass for a display substrate. The transparent electrodes 180a and 180b are formed by a photoetching method or a lift-off method, wherein the photoetching method is processed by sputtering ITO or SnO₂, and the lift-off method is processed by chemical vapor deposition (CVD) of ITO or SnO₂. The bus electrodes 180a′ and 180b′ include Ag. Also, a black matrix may be formed in the sustain electrode pairs, and includes a low-melting point glass and a black pigment.

An upper dielectric layer 190 is formed on the upper glass 170 where the sustain electrode pairs are formed. In this case, the upper dielectric layer 190 includes high dielectric particles 192 in addition to a low-melting point glass and a filler. Also, each of the high dielectric particles 192 includes TiO₂ or BaTiO₃, and has a size greater than at least 1 micrometer. In other words, in order to increase wall charges, the size of the high dielectric particle 192 should be greater than 1 micrometer. If the high dielectric particle 192 has a spherical shape, its size means a length of a diameter. If the high dielectric particle 192 has a hexahedral shape, its size means a length of a diameter belonging to one side.

The aforementioned high dielectric particle 192 should have a dielectric ratio greater than at least 20 in order to achieve predetermined objectives. If the high dielectric particle 192 has a higher dielectric ratio, it is expected that greater effects can be obtained. However, it is difficult to find a material having a dielectric ratio greater than 100. At least ten or more high dielectric particles 192 are included in one sub-pixel. In this case, the amount of the wall charges accumulated on the surface of the dielectric layer can be increased on the condition that the number of the high dielectric particles 192 should be greater than 10.

Furthermore, the upper dielectric layer 190 has a thickness of about 30 to 40 micrometer, and it is preferable that the size of the high dielectric particle 192 does not exceed about 3/2 of the thickness of the upper dielectric layer 190.

A protective layer 195 is formed on the upper dielectric layer 190 to protect the upper dielectric layer 190 from impact of (+) ion during discharge and increase secondary electron emission.

In FIG. 1, if discharge starts, wall charges are accumulated in a portion ‘A’ of the surface of the protective layer 195. In this case, the amount of the wall charges increases as compared with the conventional plasma display panel.

FIG. 2 is a sectional view illustrating a front panel of a plasma display panel according to the second embodiment of the present invention. The second embodiment of an upper panel of the plasma display panel according to the present invention will be described with reference to FIG. 2.

Although the second embodiment is basically the same as the aforementioned first embodiment, the high dielectric particles 192 are concentrated on the bus electrodes 180a′ and 180b′ in the second embodiment. Unlike the second embodiment, the high dielectric particles 192 are uniformly distributed within the dielectric layer 190 in the first embodiment. The size and composition of the high dielectric particles according to the second embodiment are the same as those of the high dielectric particles according to the first embodiment.

In the plasma display panel according to the second embodiment of the present invention, capacitance locally increases due to high dielectric particles provided inside the dielectric layer of the front panel during discharge. Accordingly, charged particles are locally accumulated in the dielectric layer where the high dielectric particles are located. For this reason, the amount of local wall charges increases so as to obtain stable discharge characteristics.

Furthermore, although not shown, high dielectric particles may be included in bus electrodes as another embodiment. At this time, the bus electrodes are comprised in such a manner that high dielectric particles are included in Ag particles.

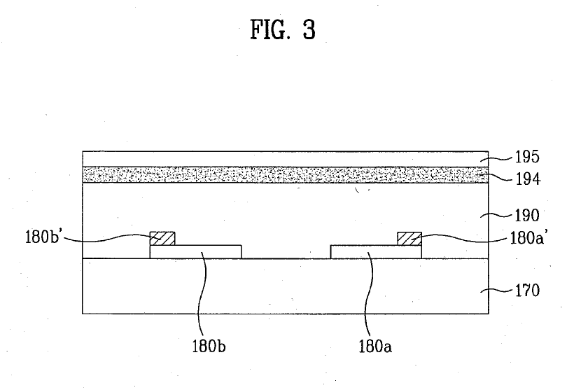

FIG. 3 is a sectional view illustrating a front panel of a plasma display panel according to the third embodiment of the present invention. The third embodiment of an upper panel of the plasma display panel according to the present invention will be described with reference to FIG. 3.

Although the third embodiment is basically the same as the aforementioned first embodiment, high dielectric particles constitute one layer 194. In other words, as shown, the high dielectric particle layer 194 is formed as a separate layer on the dielectric layer 190. The high dielectric particle layer 194 has a thickness of 1 micrometer to 16 micrometer. Although the dielectric layer 190 conventionally has a thickness of 30 to 40 micrometer, it will have a thin thickness equivalent to the thickness of the high dielectric particle layer 194. Also, although the high dielectric particle layer 194 is provided between the protective layer 195 and the dielectric layer 190 as shown, the high dielectric particle layer 194 may be formed to abut the sustain electrode pairs.

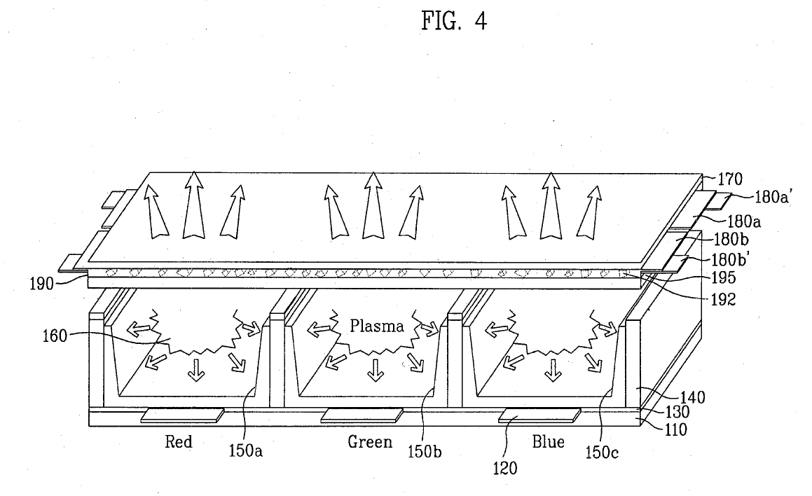

FIG. 4 illustrates a plasma display panel according to one embodiment of the present invention.

As shown in FIG. 4, a front panel of the plasma display panel according to the present invention includes sustain electrode pairs consisting of a pair of transparent electrodes 180a and 180b of indium tin oxide (ITO) formed on a front substrate 170 in one direction, and a pair of bus electrodes 180a′ and 180b′ of a metal material. The front panel of the plasma display panel according to the present invention further includes a dielectric layer 190 and a protective layer 195, which are sequentially formed on the entire surface of the front substrate 170 while covering the sustain electrode pairs.

The front panel, as shown in FIG. 1 to FIG. 3, may be comprised in such a manner that high dielectric particles are included in the dielectric layer 190 or they constitute a separate layer.

Meanwhile, address electrodes 120 are formed on one side of a rear substrate 110 to cross the sustain electrode pairs, and a white dielectric layer 130 is formed on the entire surface of the rear substrate 110 while covering the address electrodes 120. The white dielectric layer 130 is deposited by a printing method or a film laminating method and then is completed by a firing process. Barriers 140 are formed on the white dielectric layer 130, so as to be arranged between the respective address electrodes 120. The barrier 140 may be a stripe-type, a well-type, or a delta-type.

The barrier includes inorganic matters, such as parent glass and filler, and organic matters such as a solvent, a binder and a dispersing agent. Examples of the parent glass include lead parent glass and lead free parent glass. Examples of the lead parent glass include ZnO, PbO and B₂O₃. Examples of the lead free parent glass include ZnO, B₂O₃, BaO, SrO, and CaO. Also, examples of the filler include SiO₂, Al₂O₃, ZnO, and TiO₂.

A black top may be formed on the barriers 140. Phosphor layers 150a, 150b and 150c of red (R), green (G), and blue (B) are formed between the respective barriers 140. Parts where the address electrodes 120 on the rear substrate 110 cross the sustain electrode pairs on the front substrate 170 respectively constitute discharge cells.

The front substrate 170 and the rear substrate 110 are bonded to each other by interposing the barriers therebetween. In this case, the front substrate 170 and the rear substrate 110 are bonded to each other through a sealant provided outside the substrate.

The upper panel and the lower panel are connected with a driving gear.

FIG. 5 illustrates a driving gear and a connecting part of the plasma display panel according to the present invention. Hereinafter, the driving gear and the connecting part of the aforementioned panel will be described with reference to FIG. 5.

As shown in FIG. 5, the plasma display device includes a panel 220, a driving substrate 230 supplying a driving voltage to the panel 220, and a tape carrier package (TCP) 240 which is a kind of a flexible substrate which connects electrodes of each cell of the panel 220 with the driving substrate 230. The panel 220 includes the front substrate, the rear substrate, and the barriers, as described above.

An anisotropic conductive film (ACF) is used for electrical and physical connection of the panel 220 and the TCP 240 and electrical and physical connection of the TCP 240 and the driving substrate 230. The ACF is a conductive resin film made by using a ball of Ni coated with Au.

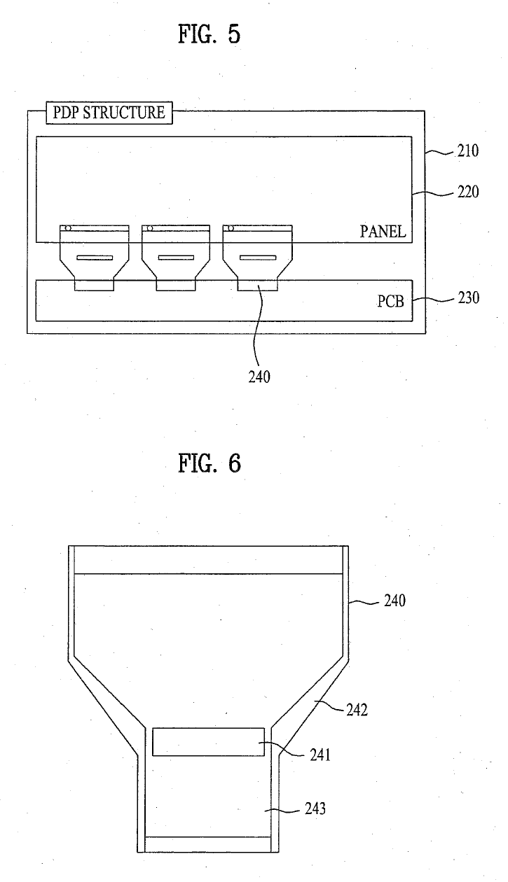

FIG. 6 illustrates a substrate line structure of a general tape carrier package.

As shown in FIG. 6, the TCP 240 is in charge of disconnection between the panel 220 and the driving substrate 230, and is provided with a driving driver chip. The TCP 240 includes a line 243 densely arranged on the flexible substrate 242, and a driving driver chip 241 connected with the line 243 and supplied with the power from the driving substrate 230 to supply the power to a specific electrode of the panel 220. In this case, since the driving driver chip 241 is applied with a small number of voltages and driving control signals to alternately output a lot of signals of high power, a small number of lines are connected with the driving substrate 230 while a lot of lines are connected with the panel 320. Accordingly, the lines of the driving driver chip 241 may be connected by using a space at the driving substrate 230. As a result, the lines 243 may not be delimited based on the driving driver chip 241.

FIG. 7 illustrates a plasma display panel according to another embodiment of the present invention.

In this embodiment, the panel 220 is connected with the driving gear through a flexible printed circuit (FPC) 250. In this case, the FPC 250 is a film in which a pattern is formed by polymide. Also, in this embodiment, the FPC 250 and the panel 220 are connected with each other through the ACF. Moreover, in this embodiment, the driving substrate 230 is a PCB circuit.

The driving gear includes a data driver, a scan driver, and a sustain driver. The data driver is connected with the address electrodes to apply data pulses. The scan driver is connected with a scan electrode and supplies a ramp-up waveform, a ramp-down waveform, a scan pulse and a sustain pulse. The sustain driver applies the sustain pulse and a DC voltage to a common sustain electrode.

The plasma display panel is driven during a reset period, an address period and a sustain period. The ramp-up waveform is simultaneously applied to the scan electrodes during the reset period. Negative polarity scan pulses are sequentially applied to the scan electrodes during the address period and simultaneously synchronized with the scan pulse so as to apply positive polarity data pulses to the address electrodes. Also, sustain pulses are alternately applied to the scan electrodes and the sustain electrodes during the sustain period.

According to another embodiment of the present invention, the aforementioned hybrid binder may be provided within the dielectric layer of the rear substrate. In other words, a parent glass, a filler and a hybrid binder are used in the process of forming a white dielectric layer. At this time, the white dielectric layer may be fired together with the barriers. Since the hybrid binder has characteristics of an inorganic matter in its organic matter, strength of the barriers can be improved and also a bonding force between the hybrid binder and the lower dielectric layer can be increased.

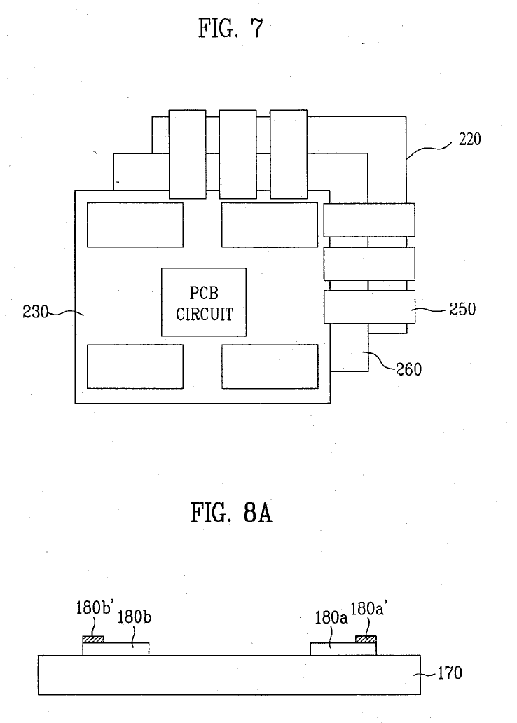

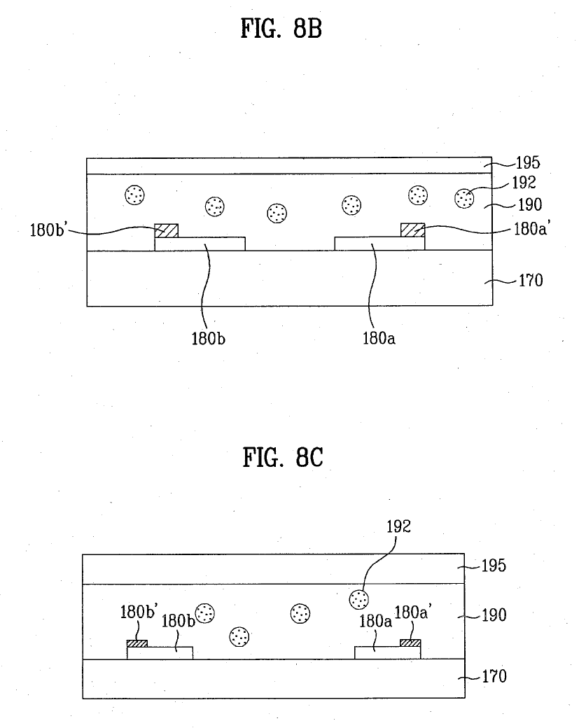

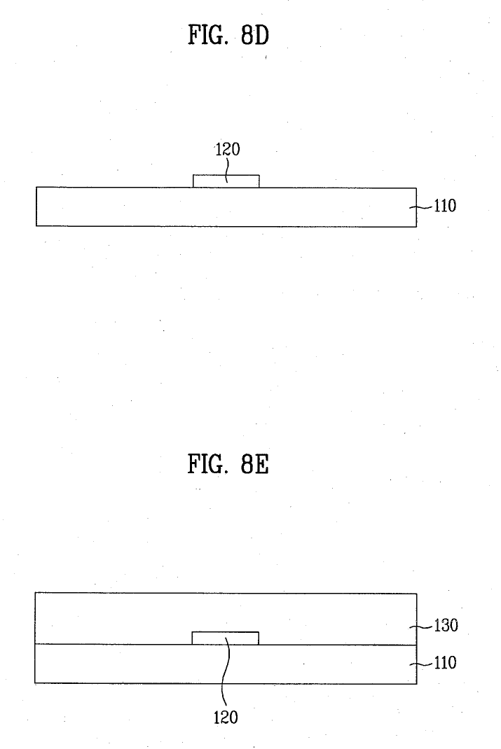

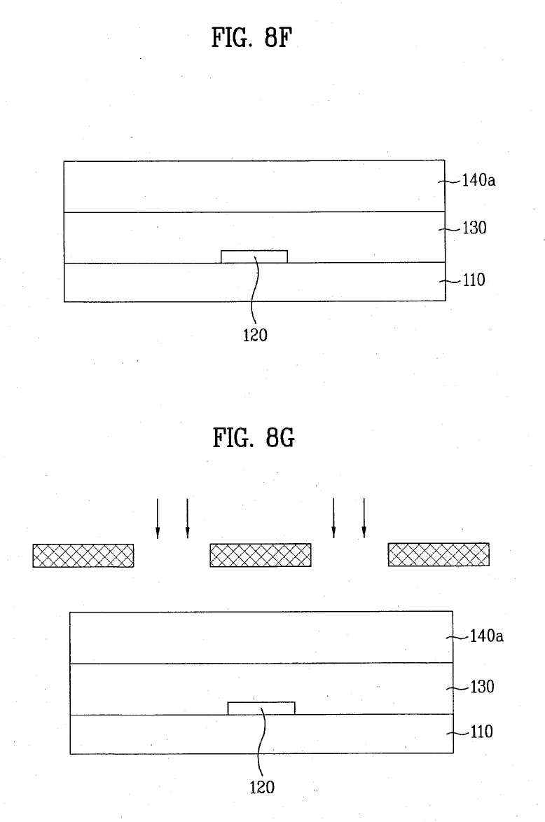

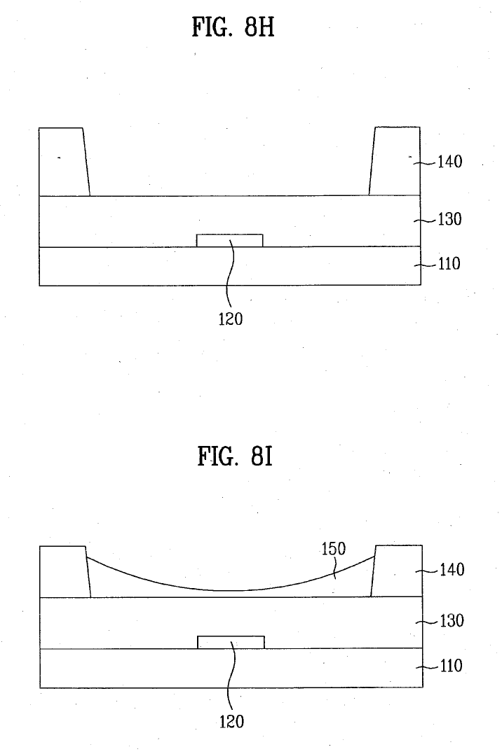

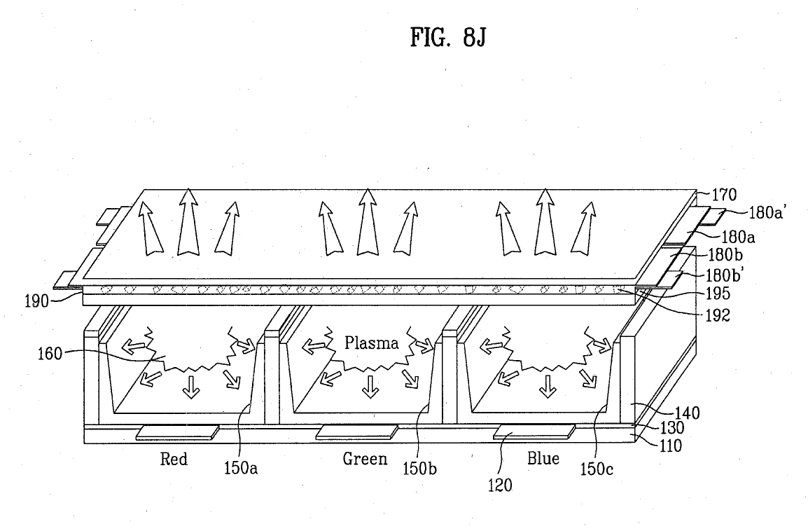

FIG. 8A to FIG. 8J illustrate a method for fabricating a plasma display panel according to the embodiment of the present invention. The method for fabricating the plasma display panel according to the present invention will be described with reference to FIG. 8A to FIG. 8J.

First of all, as shown in FIG. 8A, transparent electrodes 180a and 180b and bus electrodes 180a′ and 180b′ are formed on the front substrate 170. The front substrate 170 is fabricated by milling and cleaning either glass for display substrate or sodalime glass. The transparent electrode 180a is formed by a photoetching method or a lift-off method, wherein the photoetching method is processed by sputtering ITO or SnO₂, and the lift-off method is processed by chemical vapor deposition (CVD) of ITO or SnO₂. The bus electrode 180a′ is formed by a screen printing method or a photosensitive paste method of a material such as Ag. Also, a black matrix may be formed in the sustain electrode pairs by a screen printing method or a photosensitive paste method of a low-melting point glass and a black pigment.

Subsequently, as shown in FIG. 8B, the dielectric layer 190 is formed on the glass where the sustain electrode pairs are formed. The process of forming the dielectric layer 190 will be described in detail.

First of all, a dielectric material is prepared.

The dielectric layer is fabricated in such a manner that high dielectric particles of TiO₂ or BaTiO₃, parent glass and filler are milled, and a binder, a dispersing agent and a solvent are mixed with one another. The aforementioned material is coated on the front substrate 170 through a screen printing method, a coating method or a laminating method of a green sheet. The size and the content of high dielectric particles are the same as aforementioned.

The dielectric and the high dielectric particle layer may be formed separately as shown in FIG. 3. At this time, the dielectric layer may be formed in the same process as the conventional process, and the high dielectric particle layer may be formed separately. In this case, the high dielectric particle layer is formed in such a manner that a material containing TiO₂ and/or BaTiO₃ is coated and then dried and/or fired.

Subsequently, as shown in FIG. 8C, the protective layer 195 is deposited on the dielectric layer 190. The protective layer 195 is made of MgO, and may include silicon as a dopant. In this case, the protective layer 195 may be formed by a CVD method, an E-beam method, an ion-plating method, a sol-gel method, and a sputtering method.

As shown in FIG. 8D, the address electrode is formed on the rear substrate 110. In this case, the rear substrate 110 is formed by a process such as milling or cleaning of either glass for display substrate or sodalime glass. Subsequently, the address electrode 120 is formed on the rear substrate 110. The address electrode 120 is formed of a material, such as Ag, by a screen printing method, a photosensitive paste method, or a photoetching method after sputtering.

As shown in FIG. 8E, the dielectric layer 130 is formed on the rear substrate 110 where the address electrode 120 is formed. The material of the dielectric layer 130 is fabricated in a state of a paste by mixing glass and a vehicle with an organic solvent. At this time, the material of the lower dielectric layer is made of a material of glass-ceramics having a reflection ratio of about 50% or greater to visible lights. The paste is coated on the lower glass 110 where the address electrode 120 is formed, by the screen printing method, at a thickness of 20 to 30 micrometer. Subsequently, the lower dielectric material is dried and fired, so as to complete the lower dielectric layer 130. At this time, the drying temperature is in the range of 100° C., and the firing temperature is in the range of 500° C. to 550° C. Of course, the drying temperature and the firing temperature are varied depending on ingredients and composition of the lower dielectric material. The aforementioned method is an example of forming the lower dielectric layer by means of a screen printing method.

The lower dielectric layer 130 formed by the aforementioned method reflects visible lights emitted from the phosphor by back scattering. Accordingly, it is possible to increase luminance of the plasma display panel and prevent atoms from being diffused from the address electrode.

Subsequently, as shown in FIG. 8F to FIG. 8H, barriers for dividing the respective discharge cells from each other are formed.

First of all, as shown in FIG. 8F, the photosensitive barrier material 140a is deposited on the lower panel (second panel). In this case, the photosensitive barrier material 140a is prepared by using a green sheet, so that the green sheet is laminated on the lower panel.

Subsequently, the photosensitive barrier material 140a is processed as shown in FIG. 8G and FIG. 8H, so as to form the barriers. At this time, as shown in FIG. 8G, after the photosensitive barrier material is masked, the photosensitive barrier material can be patterned by being selectively exposed and then being developed. At this time, if the developing process ends, a photosensitive barrier material of a portion where light is irradiated remains only as shown in FIG. 8H. Subsequently, the barriers 140 are completed by the firing process. The firing process can be performed at a temperature of 550° C. to 600° C.

Subsequently, as shown in FIG. 8I, the phosphors are coated on a side where the lower dielectric layer 130 abuts a discharge place and a side of the barrier. In this case, the phosphors of R, G and B are sequentially coated depending on each discharge cell by a screen printing method or a photosensitive paste method.

As shown in FIG. 8J, the upper panel and the lower panel are bonded to each other by interposing the barrier therebetween and then sealed. Afterwards, impurities inside the bonded panel are exhausted out and then a discharge gas 160 is injected into the bonded panel.

Hereinafter, a sealing process of the upper panel and the lower panel will be described in detail.

The sealing process is performed by a screen printing method, a dispensing method, and so on. The screen printing method is to print a sealant of a desired shape by placing patterned screens on the panel at a predetermined interval and pressurizing and transferring a paste required for the formation of the sealant. The screen printing method is advantageous in that production facilities are simple and utility of the material is high.

The dispensing method is to form the sealant by using CAD line data used for fabrication of a screen mask and by directly discharging a thick film paste onto the panel using air pressure. The dispensing method is advantageous in that the production cost of a mask is reduced and high degree of freedom is obtained to form a thick film.

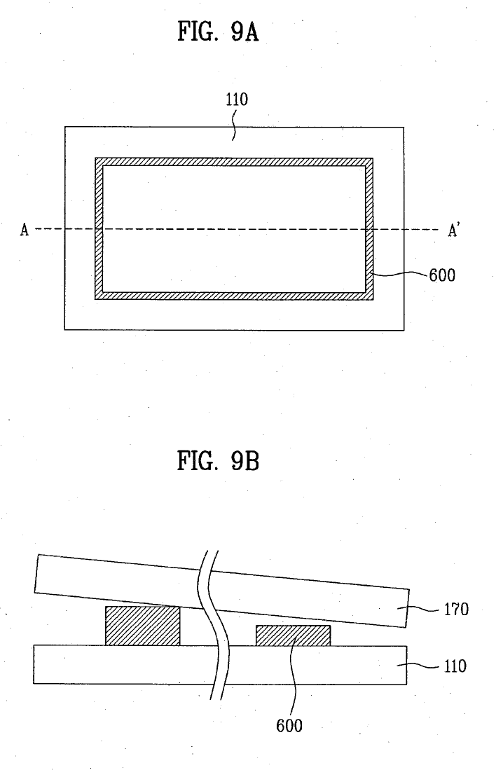

FIG. 9A illustrates a bonding process of a front substrate and a rear substrate of the plasma display panel, and FIG. 9B is a sectional view taken along line A-A′ of FIG. 9A.

As shown, a sealant 600 is coated on the front substrate 170 or the rear substrate 110. Specifically, the sealant is coated by being printed or dispensed at a predetermined interval from the outmost of the substrate.

Subsequently, the sealant 600 is fired. In this firing process, the organic matter included in the sealant 600 is removed, and the front substrate 170 is bonded to the rear substrate 110. Also, in this firing process, the width of the sealant may become wide and its height may be lowered. Although the sealant 600 may be printed or coated in this embodiment, the sealant may be formed in the form of a sealing tape, so that the sealing tape may be bonded to the front substrate or the rear substrate.

Also, characteristics of the protective layer can be improved at the firing temperature through an aging process.

A front filter may be formed on the front substrate. The front filter is provided with an electromagnetic interference (EMI) shielding film for shielding EMI emitted from the panel to the outside. Also, the EMI shielding film may pattern a conductive material in a specific type to obtain visible light transmittance required for the display device. The front filter may further be provided with near-infrared shielding film, a color compensating film, and an antireflective film.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A plasma display panel comprising:
a first panel provided with an address electrode, a first dielectric layer, and a phosphor on a first substrate; and
a second panel bonded to the first panel by interposing a barrier therebetween, including a transparent electrode, a bus electrode, a second dielectric layer provided with high dielectric particles, and a protective layer on a second substrate.

2. The plasma display panel as claimed in claim 1, wherein the high dielectric particles are formed to correspond to the bus electrode.

3. The plasma display panel as claimed in claim 1, wherein the high dielectric particles are formed to abut the bus electrode.

4. The plasma display panel as claimed in claim 1, wherein the high dielectric particles are TiO₂ or BaTiO₃.

5. The plasma display panel as claimed in claim 1, wherein at least ten high dielectric particles are formed per one sub-pixel.

6. The plasma display panel as claimed in claim 1, wherein the high dielectric particles have a size of at least 1 micrometer.

7. The plasma display panel as claimed in claim 1, wherein the high dielectric particles have a size less than 3/2 of a thickness of the second dielectric.

8. The plasma display panel as claimed in claim 1, wherein the high dielectric particles have a dielectric ratio of at least 20.

9. A plasma display panel comprising:
a first panel provided with an address electrode, a first dielectric layer, and a phosphor on a first substrate; and
a second panel bonded to the first panel by interposing a barrier therebetween, including a transparent electrode, a bus electrode, a second dielectric layer, a third dielectric provided with high dielectric particles, and a protective layer.

10. The plasma display panel as claimed in claim 9, wherein the high dielectric particles are TiO₂ or BaTiO₃.

11. The plasma display panel as claimed in claim 9, wherein at least ten high dielectric particles are formed per one sub-pixel.

12. The plasma display panel as claimed in claim 9, wherein the high dielectric particles have a size of at least 1 micrometer.

13. The plasma display panel as claimed in claim 9, wherein the high dielectric particles have a size less than 3/2 of a thickness of the second dielectric.

14. The plasma display panel as claimed in claim 9, wherein the high dielectric particles have a dielectric ratio of at least 20.

15. A method for fabricating a plasma display panel comprising:
forming an address electrode, a first dielectric layer, and a barrier on a first substrate;
coating a phosphor within a cell divided by the barrier;
forming a transparent electrode and a bus electrode on a second substrate;
coating, drying and firing a second dielectric material including high dielectric particles on the second substrate;
forming a protective layer on the second dielectric layer; and
bonding the first substrate and the second substrate to each other.

16. The method as claimed in claim 15, wherein the high dielectric particles are coated by constituting a separate layer.

17. The method as claimed in claim 15, wherein the second dielectric material is fabricated in such a manner that high dielectric particles of TiO₂ or BaTiO₃, parent glass and filler are milled, and a binder, a dispersing agent and a solvent are mixed with one another.

18. The method as claimed in claim 15, wherein coating the second dielectric material includes coating the second dielectric material by allowing the high dielectric particles to correspond to the bus electrode.

19. The method as claimed in claim 15, wherein coating the second dielectric material includes coating the second dielectric material by allowing the high dielectric particles to abut the bus electrode.

20. The method as claimed in claim 15, wherein coating the second dielectric material is performed by a screen printing method, a coating method, or a laminating method of a green sheet.
